(19) United States
(12) Patent Application Publication
(10) Pub. No.: US 2019/0286882 A1
(43) Pub. Date: Sep. 19, 2019

(54) Method, apparatus and product for item identification and search on a scene using fluorescence

(71) Applicant: Jaroslav Hook, Melbourne, FL (US)

(72) Inventor: Jaroslav Hook, Melbourne, FL (US)

(21) Appl. No.: 15/924,269

(22) Filed: Mar. 18, 2018

(51) Int. Cl. G06K 9/00; G06T 7/90

(52) U.S. Cl. CPC G06K 9/00181; G06K 2209/21; G06T 7/90

(57) ABSTRACT

A method, apparatus and product for items identification and search on the scene are disclosed. It comprises Fluorescent Marker and Fluorescent Marker Reader. Florescent Marker further comprises a Plurality Dynamic Fluorescent Entities enclosed in a Transparent Solid Medium, wherein the said medium is built into the item under consideration. The said Fluorescent Marker Reader further comprises Activator used to illuminate the said. Fluorescent Marker Reader further comprises Camera used to capture the response from the said Plurality of dynamic fluorescent entities, Activator generating activating light pulses, Visualizing Screen and Computation Unit. The latter controls the said Activator, Camera, Visualizing Screen and matches dynamic/spectral response against previously stored pattern thus identifying the said item or locating it on the scene.

### REFERENCES CITED

The below references are incorporated by the reference herein in their entirety and relied upon.

### U.S. PATENT DOCUMENTS

[1] Application 2010/0062194 A 6 Jun. 2002 Crane, Prehar, Calif.
[2] U.S. Pat. No. 8,034,398 B2, 2011 A 6 Jun. 2002 Gary Ross,

### OTHER PUBLICATIONS

[3] Japan Association for Medical Device Industries, (JAMDI) Technical Guideline on Direct Marking for Two-Dimensional Symbol Steel Instruments, 2013
[4] Sterile Processing University, Module 25: Inventory Control Management, LLC 2012
[5] FOBA publication Application Case Study, Laser marking of reusable surgical instruments mastering multiprocess requirements
[6] Aesculap Academy publication Instrument Marking System CIS Self Study Lesson Plan
[7] IEEE International Conference on RFID, April 2008 ASSIST—Automated System for Surgical Instrument and Sponge Tracking
[8] Aesculap Academy publication Creating and Maintaining Correct Instrument Set CIS Self Study Lesson Plan
[9] 3M Health care publication, Susan Klaciik textitInstrument Identification Methods, Lesson No. CRCST 143, CRCST Self-Study Lesson Plan
[11] GS1 Publication, Japan, GS1 Data Matrix Direct Marking Guideline for Surgical Steel Instruments
[12] GS1 Publication, Japan, Technologies for Marking Surgical Instruments, guidance document
[13] Sao Paulo University Hospital Publication, March, 2010, Instituto do Cancer do Estado de Sao Paulo Octavio Frias de Oliveira—ICESP INSTRUMENT TRACKING IN THE UNIVERSITY HOSPITAL OF SAO PAULO
[15] Key Surgical Publication, keysurgical.com, KEY SURGICAL INSTRUMENT TRACKING
[16] GS1 publication, Health care Japan Instrument Marking WG, Surgical Instrument Marking Operations Guide
[18] MASTEL PRECISION SURGICAL INSTRUMENTS, INC. publication, Packaging and Sterilizing MASTEL PRECISION Marking Instruments
[19] Altrax Group Company, Instrumark publication, Report on Effectiveness of Laser Parameters when marking Surgical Instruments
[20] Sterile Processing University Publication, Nancy Chobin, 2015 Quality Preparation of Surgical Instruments
[21] World Health Organization publication, Department of Essential Health Technologies, Medical device technical series Introduction to medical equipment inventory management
[22] SIC Marking publication, Surgical instruments traceability, Reading system (product white paper)
[23] Lawson Supply Chain Management publication, May 2006, Surgical Instrument Management User Guide Document Number SIMUG-90UW-01
[24] Taylor Surgical Instrument Pty, Ltd, publication, taylorsurgical.com.au, Farbitek, Instrument Identification System, white paper
[26] AORN publication, textitRecommended Practices for Cleaning and Care of Surgical Instruments and Powered Equipment
[27] International Trade Administration publication, Sylia Mohr, Medical Devices: CE Marking Step-by Step white paper
[28] Fluorescent Nanoparticles for Ion Sensing Erlangung, Ph.D. Dissertation,
[29] Invitrogen publication, Technical resource Guide for Fluorescence Polarization
[30] Tunable photoluminescence and spectrum split from fluorinated to hydroxylated graphene by P. Gong, J. Wang et al
[31] Silver Nanoparticles As Fluorescent Probes: New Approach for Bio-imaging by Ajeet Singh, Shalinee Jha, Garima Srivastava, Preeti Sarkar, Prerana Gogoi
[32] Size- and Shape-Dependent Fluorescence Quenching of Gold Nanoparticles on Perylene Dye by Chenming Xue, Yuhua Xue et al

### FOREIGN PATENT DOCUMENTS

| | | |
|---|---|---|
| EP 2 221 020 B1 A2 | 06.08.2014 | Marczyk, Stanislaw |
| EP 2 221 020 A1 A2 | 25.08.2010 | Marczyk, Stanislaw |
| Application 88309627.3, A2 | 14.10.201988 | THOMAS DE LA RUE |

### BRIEF DESCRIPTION OF THE DRAWINGS

The accompanying drawings, which are incorporated in and constitute a part of the present specification, illustrate embodiments of this disclosure. Along with an invention summary of the disclosure given above, and the detailed description of the embodiments given below, the said drawings serve to explain the principles of the disclosure.

FIG. 1 is a cross-sectional view of item's Fluorescent Marker (Cavity embodiment) in accordance with the principles of the present disclosure;

FIG. 2 is a cross-sectional view the item's Fluorescent Marker product (Tape embodiment) in accordance with the principles of the present disclosure;

FIG. 3 shows front and side views of one possible embodiment of the Activator used to invoke an after emission response from the Fluorescent Marker of FIG. 1,2

FIG. 4a, FIG. 4b. shows a structure of the Fluorescent Marker Reader

FIG. 5 is a flowchart illustrating the search for the item on the scene, mode performed according to the invention

FIG. 6 shows an instance of several time samples of Activator's excitation signal and Fluorescent Marker's post emission polarization spectral-temporal characteristics

FIG. 7.0 shows large and detailed cross sections views of an embodiment of a Fluorescent Marker (Thread embodiment).

### OBJECTS OF THE INVENTION

The object of the present invention is a method, apparatus and product based on fluorescence/phosphorescence applied for item identification. A set of fluorescent entities has randomly distributed properties of both static and dynamic nature. The said properties are stable in time and in terms of the environment and represent a basis for such an authentication serving as a signature. A positive cross match of the said signature from an item and the one previously taken and stored in a data base provides authentication.

### BACKGROUND OF THE INVENTION

The present disclosure relates to an apparatus, method and the product [21] for item identification and search on the scene. The item identification and search is critical to practically all stages of manufactured item's lifetime from the moment they are manufactured to the storage, tracking, delivery, customer servicing and maintenance. There are multiple overlapping processes where item identification and search are relevant: inventory control and management, inventory tracking/tracing/management [22], record keeping, ownership management, risk management, housekeeping.

There is a large number of issues where identification and search is especially critical, for example for items of medical nature, medical instruments [4][11][13] and the relevant supply in particular. Human error [6] is minimized if the identification and search is automated if item is lost or missing. If there is a shortage or excess, missing items, lost business or unnecessary storage costs are incurred. The identification is critical for inventory, replenishment, planning, patient traceability, storage identification, record-keeping [10], providing fast and precise information in real time and satisfaction of the users. The search is oftentimes important during such time critical use of the medical items as operations or other medical procedures.

The identification and search of such items as medical instruments [1][2] and supply [3] [5] facilitates in managing such risks as: unavailability of the required instruments, misplaced instruments, forgotten instruments and supply, improperly processed instruments, delays in producing an required medical instrument from tray during time critical surgeries[24][16][18]. One of the most commonly used identification techniques is based on markers: entities of a size much smaller than the items which are embedded and carry a computer readable information about the item's identity. The most commonly known among the markers are bar codes, color codes and RFIDs [12]. Markers of these different types are embedded into items using various processes, which are directly related to the associated risks. The bar codes, are normally placed as tapes, electrolytic deposition, laser based etching/engraving, heat-fused nylon, dot peen, color codes are normally placed by tape. RFIDs [7] are normally get affixed on an item. The related risks here are temperature or chemical damage to the items an related loss of use.

Medical instruments normally are subjected [17] [23] [9] to several processes, which may potentially damage the said markers, especially especially such electrically active markers as RFIDs: direct use, cleaning, sterilization, drying. The damage may also occur during surgeon handling. Chemical substances used during cleaning, elevated temperatures of the sterilization and drying, misuse during user scanning, degradation of mark over period of time are possible sources of damage to markers.

There is a number of risks and disadvantages, specific to a marker type: RFIDs are not suitable for the medical instrument given a relative sizes of the RFIDs and the instrument as well as instrument processing procedures, as sterilization, which potentially may damage RFID. Bar codes oftentimes are hard to read in a cluttered or busy scenes. In addition, the said bar code readers typically have a limited reading range 3-20 inches for a a majority of such items as medical instruments where small resolution is required.

The present invention is aimed at using a physical principle different from all the previously mentioned: spectral-polarization temporal properties of the post emission fluorescent/phosphorescent response in order to to identify and search items on the scene. It turns out that the post emission fluorescence characteristics are determined by manufacturing conditions. Moreover the after emission lifetimes are typically longer for the phosphorescence.

From Ph.D. Dissertation [26] Fluorescent Nanoparticles for Ion Sensing by Erlangung, it is known that phosphorescent materials generally have much longer after emission lifetimes than one for a typical fluorescent process due to a different role of electron's spin. As it turns out fluorescent spin causes energy transition process to occur with faster emission rates and hence, it results in much shorter fluorescence lifetimes in the range of a few nanosecond as compared with milliseconds and above for phosphorescence which is a special case of fluorescence. A special family of the counterfeiting optical markers are the ones based on the effect known in non linear optics: From the aforementioned dissertation we also know that the fluorescence is a non linear optical effect which is an longer wavelength light emission after being exposed to light of a shorter wavelength. At item marker containing multiple entities (small particles in most of cases) of fluorescent materials, may be embedded in an item in a way, which may not even be observable by human eye, unless it is activated by ultraviolet illumination.

From Invitrogen publication technical resource Guide for Fluorescence Polarization [27] we know that light emitted by many fluorescent materials may have different degree of polarization which depends on the incident polarization in a complex way, and chemical composition of the material. The estimate of the degree of polarization may be performed as a weighted mean of two light magnitudes filtered by perpendicularly oriented polarized filters.

From publication Tunable photoluminescence and spectrum split from fluorinated to hydroxylated graphene by P. Gong, J. Wang et al.[28] we know that a graphene based fluorescent material hydroxylated graphene (HOG) made from fluorinated graphene exhibits a high degree of tunable emission with wavelength ranging from greenish white (343 . . . 392 nm) to deep blue (156 . . . 94 nm) nanometers. From the 3 aforementioned references we also can conclude that all these characteristics can be a basis of a particular embodiment of a temporal fluorescent feature.

From the publication [29] Silver Nanoparticles As Fluorescent Probes: New Approach for Bio-imaging by Ajeet Singh, Shalinee Jha, Garima Srivastava, Preeti-Sarkar, Prerana Gogoi it is known that silver nanoparticles possessing fluorescent properties could be created using chemical reduction of silver nitrate and characterized using NMR and FT-IR and could be injected into the human body for medical imaging. The use of such particles indicates the existence of fluorescent materials which are safe for humans, hence may be used for the items with other purposes for identification.

From Size- and Shape-Dependent Fluorescence Quenching of Gold Nanoparticles on Perylene Dye by Chenming Xue, Yuhua Xue et al. at wileyonlinelibrary.com [30] it is known that the gold nanoparticles have fluorescent properties in the range 600 nanometers and up. The named emission properties of some materials make them fluorescent phosphorescent which is directly relevant to the object of this invention. The time characteristics of the phosphorescent post emission are especially important since their values are large enough so that they can be reliably measured using readily available devices, such as a cell phone camera.

### SUMMARY OF THE INVENTION

The foregoing and other problems are overcome, and other advantages are realized, in accordance with the presently preferred embodiments of the present invention. The present invention is an advancement over the prior art since their use eases the identification and search of the items.

In the present detailed description, a number of specific details is provided in order to facilitate a thorough understanding of the invention. Nevertheless, it may be understood by those skilled in the art that the said invention may be practiced without these specific details. In other cases, well-known techniques, procedures, and components have not been described in a great level of detail so as not to obscure the present invention. The present invention is method, apparatus and product which addresses two main problems, discussed in the background: item identification and search on the scene.

The present invention is aimed to identify and search items on scene using a physical principle different from all the previously mentioned: it uses spectral-polarization temporal properties of the post emission fluorescent/phosphorescent response, which is easy to produce and utilize.

The method in accordance with the invention consists in illuminating with light of a controlled spectrum range and duration a marker, further named Fluorescent Marker (FM). The said FM comprises a plurality of fluorescent entities (PDFE) scattered inside Transparent Solid Medium (TSM) wherein the said TSM which fills in a space made on the surface of the item to be identified. The three elements: PDFE, TSM and the said Cavity together make Fluorescent Marker (FM). In an alternative embedding of the said FM the said TSM is shaped as a layer on the said item's surface or a plurality of threads wrapped around the said item.

The key group of physical properties used in this invention is spectra/polarization temporal properties of phosphorescent/fluorescent after emission, further referred as After Emission Signature (AES). Spectral emission, time delay and polarization properties of the said fluorescent entities are randomly distributed. The resulting variety of the combinations provides a sufficiently diverse combined resulting spectral temporal response characteristics of different Fluorescent Markers.

The said diversity makes for unique AES of the said Fluorescent Marker. The said AES may be thought and an object in the space of spectrum, polarization represented in time. The digitally encoded pattern makes signature stored in a data base during the item enrollment stage. The said AES is further used for the matching in the identification stage.

A fast search for a required item is made possible using selective spectrum activation to highlight the Fluorescent Markers on the chosen items. This is achieved by tailoring the activation illumination is such a way that only the markers of the searched items emit visible light thus enabling the user to quickly find the item. Alternatively the searched item's markers may be highlighted on the user's screen.

Therefore major advantages of the proposed invention can be summarized as follows:

1) Contrarily to the existing state of-the-art approaches, herein utilization the fluorescent spectral, temporal and polarizing properties is proposed in order to boost the feature space of possible post emission characteristic patterns of the said Fluorescent Markers, thus increasing the degree of uniqueness of an individual marker, which in turn gives an identity to an item, whereupon the said FM is mounted. None of the previous approaches uses temporal or polarization properties of the fluorescent spectrum as an identifying signature.

2) Due to the inherently better noise resistance of the spectral, polarization, temporal patterns, given physical nature fluorescence the pattern matching is more robust than the bar codes or color codes known to those skilled in prior art. The bar codes are printed and extracted as light intensity magnitudes, which is inherently less noise resistant than the said spectrum, polarization or temporal characteristics.

3) Contrarily to the previously developed state-of-the-art approaches, the said Fluorescent Markers are the parts of the item, targeted by a light source further called Activator. This fact makes the spectrum and energy characteristics of post emissions of the said Fluorescent Markers different from the reflected optical energy of non fluorescent rest of the scene. The after emission of the said FM will comprise a spectral wavelengths not present in the Activator. The said property is made possible by the inherent nonlinearity of the fluorescence effect and an activator's spectrum specially pre-tailored to the combination of the response of the expected set of florescent markers. These facts enable an easier separation of the markers from the rest of the scene, unlike state-of-the-art bar codes which have the similar spectral-polarization-temporal characteristics as the rest of the scene and need to be identified based on their spatial intensity patterns.

4) Due to use of angle invariant spectral-polarization-temporal characteristics of the Fluorescent Markers, their respective readers can operate at very blunt incidence angles (as little as 10 degrees to the surface plane) unlike bar codes readers which oftentimes require angles for their operations close to perpendicular (at least 60 degrees). This capacity facilitates and speeds up user's work.

5) Due to use of temporal dimension in spectral-polarization-temporal characteristics of the Fluorescent Markers (FM), their respective Fluorescent Marker Readers(FMR) can operate at larger distances than bar codes readers which require a certain spatial resolution thus limiting the range of the operations.

6) Due to the use of temporal spectral characteristics of the FMs, their respective FMRs can operate at busy and noisy scenes inherently better than bar codes readers. The later may have limited computational capacity and have to execute computationally intensive image processing algorithms to identify the said bar codes among such a busy scene.

7) Due to the property of manufacture controlled after emission delay and spectrum it becomes possible to identify visually a chosen item by simply tailoring the said Activator emission spectrum so that only chosen subset of the marker's become activated and start emitting the lights, for a visual detection by user: only the chosen items will have markers with after emission on them.

8) Contrarily to the existing approaches item Search on the Scene where they are easy to find since the items highlighted, becomes possible and easy to implement.

9) Contrarily to color coding wherein the information is encoded only in spectral terms, fluorescent markers have much richer information content due to added two dimensions: polarization and time.

Further particular methods approaches and structure of the apparatus of the subject invention will become more apparent from the detailed description of the preferred embodiments together with the respective drawings.

### DETAILED DESCRIPTION OF THE PREFERRED EMBODIMENTS

The present invention further provides apparatus, method and product for item identification and search on the scene having at least one described marker embedded therein and/or mounted thereon. Other features and advantages of the invention will be obvious to those skilled in art from the detailed description foregoing accompanying drawings. Unless stated otherwise, all technical terms utilized herein have the same meaning as generally accepted by those skilled in the art. All references, applications for patent or granted patents or any other references used herein are included by list of reference in their entirety. Should a conflict arises, the present description, including definitions, will overrule. Moreover, the materials, techniques, and any examples are for illustration purpose only and not intended to be limiting.

The present invention is aimed to identify and search on the scene items using a physical principle different from the prior art. The said principle relies on of diverse spectral-polarization temporal properties of the after emission fluorescent/phosphorescent response of Florescent Markers, built in the item and serving as item's identity. For the purpose of brevity the term ‘fluorescent’ will further signify both fluorescent and phosphorescent. A particular trait of the phosphoresce subset of the fluorescence effect is much larger delay times which enables its sampling by a sequence of the capture frames and further processing.

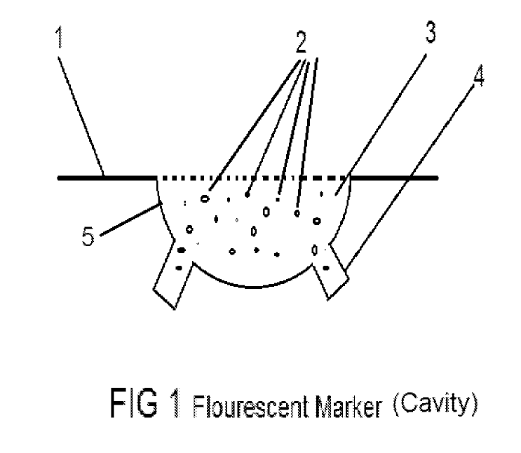

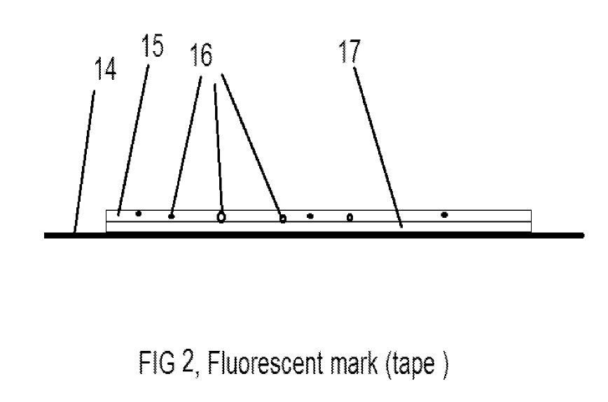

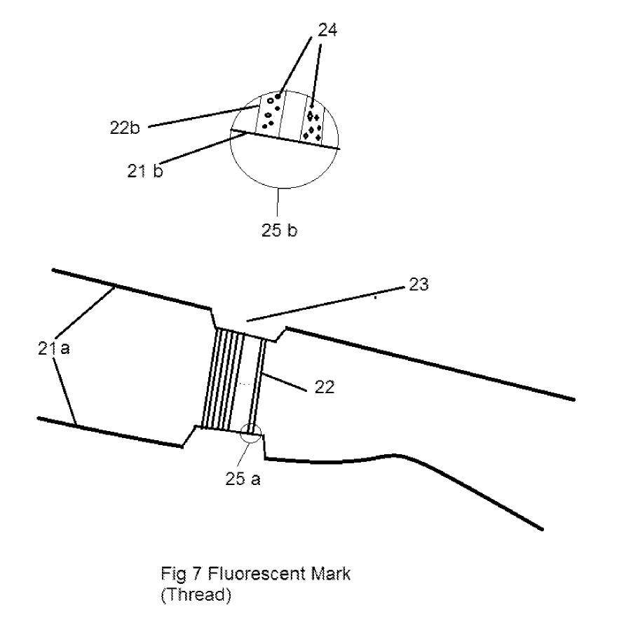

Understanding of the invention will be enhanced with FIG. 1, FIG. 2, FIG. 7 which show three possible alternative embodiments of the said Fluorescent Marker (FM), each comprising Plurality of Fluorescent Entities (PDFE) distributed within said Transparent Solid Medium (TSM) enclosed within the said Cavity (5) of FIG. 1 or in an alternative embodiment where in the said TSM represents a flat layer (15) shown FIG. 2. of a type ‘Tape’, or yet another embodiment which is shown on FIG. 7 of type ‘Thread’.

Understanding of the first embodiment of the said FM will be further enhanced with the aid of FIG. 1. The item's surface contains a Cavity (5) of an arbitrary shape also comprises at least two Outlets(4). The said Cavity is located below the plane of the item's surface. The said Cavity (5) is filled in with the Transparent Solid Medium (TSM) (3). The said outlets are shaped in order to keep the TSM firmly inside the said Cavity. The maximum size at the cross section of the said Cavity is kept 5 mm or at most ¼ of the cross-section of the surrounding item's area, whichever is smaller. In a preferred embodiment shown on FIG. 1 the said TSM top's surface is aligned with the same of the said item. Furthermore the said TSM contains a randomly distributed PDFE (2,16 of FIG. 1, FIG. 2 respectively). A particular material for TSM could be selected by those skilled in art.

In the second embodiment of the fluorescent marker has a flat shape shown on FIG. 2, wherein the TSM's top surface does not elevate above he said item's surface (14) more than 2 mm. It comprises a layer of TSM (15) with enclosures at least one fluorescent/phosphorescent Particle (FPP) wherein FPP form Plurality of PDFE (16). The said TSM (15) is attached to the item's surface by an adhesive material (17).

Understanding of the third embodiment of the said FM (the ‘Thread’) will be further enhanced with the aid of FIG. 7. The said Thread” embodiment is best used for long items with a smaller width. FIG. 7 shows a large and detailed views of the an item's cross section: (21 a, b). A circumferential cavity 23 of a depth of he most 1 mm. The marker comprises a plurality of threads (22 a,b) wrapped around he said item's circumferential cavity (23). Each of the said threads further comprises a TSM as in two previous embodiments forming the thread's shape and PDFE scattered around the said TSM. The said PDFE (24) have identical properties within each thread, but distinct across different threads. A particular material for the thread's TSM could be selected by those skilled in art.

The said PDFE (2) comprises at least one individual Fluorescent/Phosphorescent Particle (FPP) of a maximum size of 0.1 mm. The critical physical properties of the said FPP are polarization degree, after emission spectrum, the associated time delay. The said after emission spectrum average of each said particle (FPP) is randomly distributed within 300 through 1000 nm with width of the spectral band of no more than 250 nanometers. The absorption spectrum is also randomly distributed within the said spectral band minus 100 nm with the width no more than 200 nm. Associated time delay is also randomly distributed on the range from 0 to 100 milliseconds.

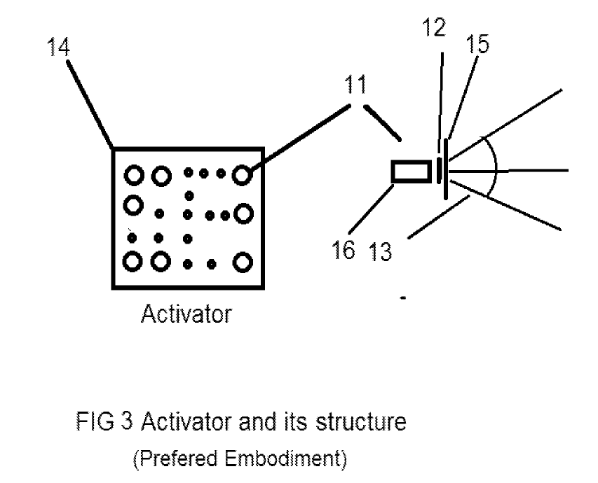

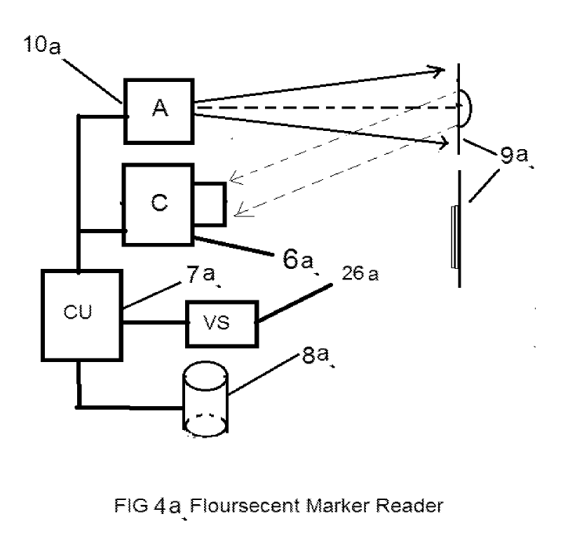

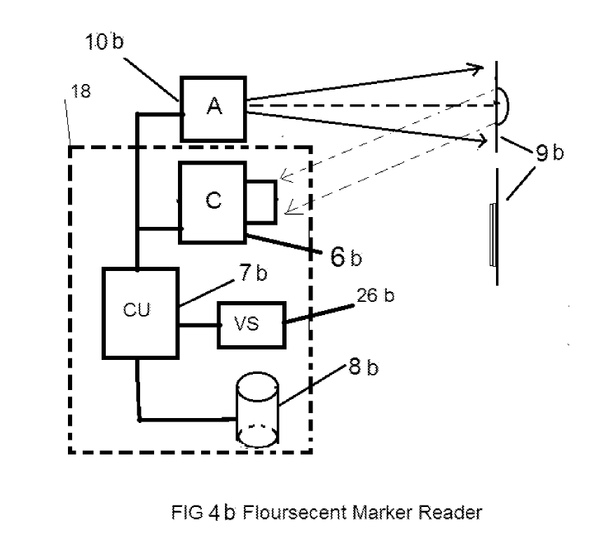

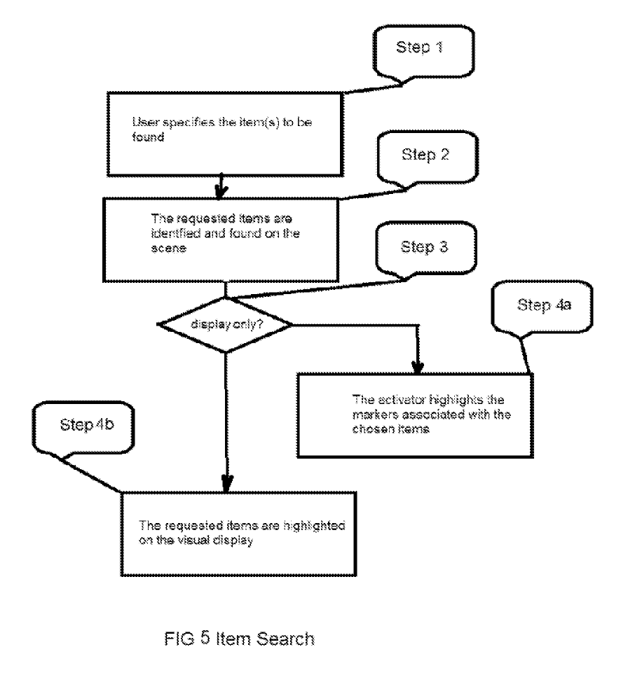

Each of the said PDFEs located on a respective FM is activated by apparatus further refereed as Activator (14) or (10a of FIG. 4 a) with structure of the preferred embodiment shown on FIG. 3. The said Activator in this preferred embodiment comprises of at least one individual narrow spectrum sources (NSS) (11). Each of the said NSSs further comprises further contains an WSS (16) with their respective color filter (CF) (12) and polarization filters (PF)(15) where in the said filters sufficient to cover spectrum within the said range of 300 through 1000 and at least two maximally spread polarizations respectively. Its function is a controlled multi wavelength, multi polarized light source. Each of the said CF is transparent only in an effective spectrum of at most than 50 nanometers. Each of the said WSS are able to emit the light within a solid angle of at least 15 degrees. The said Activator (14) is configured to switch of the said WSS (11) ON and OFF on a duration between 1 to 100 milliseconds.

With the said wavelength/polarization/duration control and coverage a properly controlled Activator (14) is able to generate a diverse controllable spectrum, polarization and duration distribution of the activation signal, with a programmed control producible by someone skilled in art. This diversity is highly desired for extraction of a fluorescent response from the said FM shown at FIG. 1, 2,7.

Each of the said plurality of NSS are designed is to have a band wavelengths 100 nanometers wide at acceptance angle no more than 30 degrees. Such a design is executable by someone skilled in art.

The use on an alternative embodiment of the said Activator is acceptable as long as it is capable to generate a light pulse of arbitrary duration, spectrum and polarization within the said requirements, if designed by someone skilled in art.

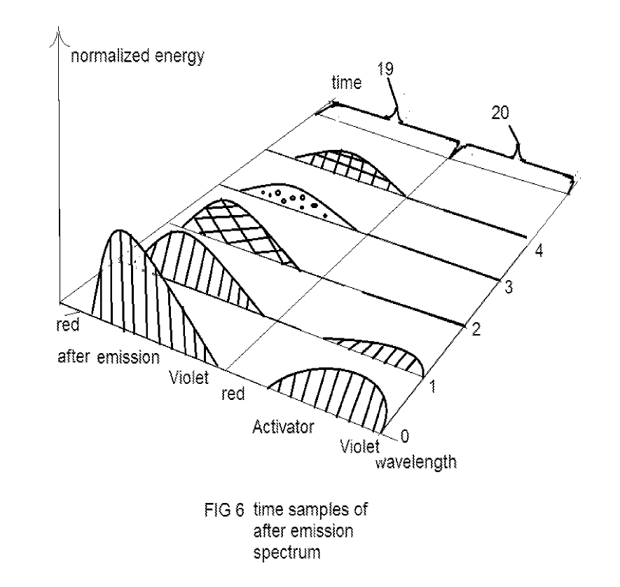

FIG. 6 shows an example of the said Activator's excitation and after emission response of said FM. This response is polarization temporal spectral characteristic, which is the key physical pattern forming the said FM's uniqueness. Sampled and stored such a characteristic forms an After Emission Signature (AES) used for further identification and matching. The polarization dimension is not shown on the drawing, due to inherent limitations of 2D representation, but is assumed to be present as an additional dimension in a said AES. The said Activator (14, FIG. 3) generates an activation light signal of the spectral temporal shape samples (19), which in turns invokes an after emission response signal from the said FM of the spectral temporal shape samples (20). The uniqueness of the said after emission for an individual marker is due to an increased space of the respective individual Fluorescent/Phosphorescent Particles (FPPs) shown at FIG. 1,2,3 characteristics forming the PDFE, wherein the said FPP is the active part of the marker thus giving an identity to an item wherein the said Fluorescent Marker is embedded.

Understanding the invention will be further enhanced with the aid of FIG. 4 a, showing a schematic a block diagram of the Fluorescent Marker Reader (FMR) apparatus. The said FMR used in the process of item identification and search on the scene. The said FMR further comprises of the said Activator (10 a of FIG. 4 a, the same as (14) of FIG. 3). The FMR also comprises Camera (6 a), Computational Unit (CU, 7 a), Data Base (DB, 8 a), Visualization Screen (VS 26 a),b)). The said CU (7 a) is programmed to control the said Activator (10 a) and the said VS used for visualization in order to to generate a activation sequence of a desired spectral temporal characteristics. The said Camera (6 a) is controlled by the said CU (7 a) in order to capture a response of the said Fluorescent Marker Reader (FMR) in any its of three possible embodiments: Cavity, Tape, Thread.

The said color Camera (6 a) is of a digital type, comprises at least 5 Megapixels and has at most 10 milliseconds per capture and reception spectrum of the range of at least 250 nm through 1200. The Computational Unit (CU, 7 a, b), is a programmable computational device, with clock frequency of at least 1 GHz, and at least 10000 MIPS. The Data Base (8 a) is an information storage, able to store at least 10 Megabytes. The said Camera, Computation Unit, Storage may be implemented by those skilled in art.

The said Fluorescent Marker Reader's preferred embodiment is shown at FIG. 4,b. It is also similar to one shown at FIG. 4b. In this embodiment a cell phone, an IPod or an analog under the generic name of Portable Computational Platform (PCP) (18) comprising a color camera (6b), Computation Unit (7b) and the Storage Device (SD) (8b). The SD may be of a type directed located physically on the said PCP or located remotely on a ‘cloud’ known to skilled in the art for all embodiments of FMR. In this embodiment the said FMR comprises the said PCP (18) with the appropriate software connected to Activator 10 b, wherein the said Activator is fully powered and controlled by the said PCP. The use of the off the shelf computation platform equipped with Cameras of the said capacity may present cost savings advantages.

Out of the three relevant operation modes, exercised by FMR are Enroll/Identification/‘Search on the Scene’ the first two are analogous to the ones, known to skilled in the art of biometric and finger print recognition. At the Enrollment mode physical spectral temporal response pattern from the FM located on the item is captured by the said Camera (6 a), and stored in Data Base (8 a) in a digital form as a record corresponding to the item where in the said FM is located. At the Identification mode the said physical spectral temporal response pattern from the said FM located on the item is captured by the said Camera (6) and matched to the ones previously stored in a form of the said AES at the Enrollment mode. Once the match result is positive against one of the records, the identification is achieved. The method used could be designed by those skilled in art of pattern recognition.

The third mode of the operation of the said FMR represents a novelty of the present invention: ‘Search on the Scene’ for a requested item on the captured scene shown on the FIG. 9. The sequence is as follows: At the Step 1 the user specifies an item (or items) or to be found on the scene among all items on the scene. Their respective spectral response characteristics represents the said After Emission Signature (AES), which is retrieved from the said Data Base 8 a of FIG. 4 a. At the Step 2 all items containing fluorescent markers on the scene are identified by using the methods from the aforementioned Identification mode. The requested list of the AESs of the Step 1 is cross matched to the AESs just found on the scene. At the Step 3 the said CP (7a,b) matches expected spectral response from all Fluorescent Markers visible on the said scene at the Step 2 (Group II) against the expected spectral response of AESs the chosen at the Step 1 (Group I). The Activator's spectral pattern is chosen to activate all AESs in Group I and NONE of the rest of the patterns from the scene (Group III=Group II−Group I). The user the user will see after glow only on the markers placed on the chosen items, thus facilitating the item search (Option A).

If the above separate activation is not possible, instead of light pulse of a particular spectrum, Activator (10 a,b) uses a sequence of individual light pulses activating spectrum for each of the patterns of the Group I in a circular wrap around scan manner (Option B). Due to inertial nature of the human sight the user will only see the afterglow on those Fluorescent Markers placed on the chosen items, thus facilitating the item search. A method of how spectrum is chosen and circular scanning as well as inertial properties of human sight are well known to those skilled in the art.

If at least one of the said options (A,B) is possible then a separate activation of each marker of the Group I becomes possible, Step 4 a) gets initiated, and the said Activator illuminates the scene according to the said Option A or B.

If exclusion of the Group III from the after emission is still not possible, Step 4b) is executed and the required items be highlighted an image of the scene which would also facilitate the search, (Option C). Moreover, said option C in another embodiment of the said ‘Search on the Scene’ mode can be also implemented using bar codes for identification instead of the said Fluorescent Markers.

It should be obvious to those skilled in the art that different variations can be performed to the structure of the present invention without departing from the scope or general spirit of the present invention. In view of the foregoing, it is intended that the present invention cover modifications and variations of this invention provided they fall within the scope of the following claims, their equivalents or analogs.

What is claimed:

1. Method, apparatus and product for identification and search of items on the scene comprising: at least two Fluorescent Markers; Fluorescent Marker Reader.

2. Cavity embodiment of Fluorescent Marker product of the claim 1 comprising: Transparent Solid Medium which has a absorption spectrum at most 10 in the relevant wavelength band; Plurality of Dynamic Fluorescent Entities embedded in the said Transparent Solid Medium, wherein the said Plurality has fluorescent response time is distributed with the standard distribution of at least of 1 nanosecond where the after emission florescent spectrum distribution, wherein both the standard deviation of the spectral width and the average wavelength of at least 50 nanometers; Cavity embedded in the item's surface, which the said Transparent Solid Medium fills in, where in the said PDFEs are distributed in randomly throughout the said cavity's space, wherein the said cavity's shape is sufficient to prevents its detachment from the said cavity item, and filled;

3. Tape embodiment of Fluorescent Marker product of the claim 1 comprising: Transparent Solid Medium as in claim 2, but in a shape of a layer at most 1 mm thick on a sticky tape applied on the item; Plurality of Dynamic Fluorescent Entities as in claim 2 placed inside of the said Transparent Solid Medium.

4. Thread embodiment of Fluorescent Marker product as in claim 2 and claim 3 comprising plurality of the threads wrapped around the item in questions, where in the said threads contain the fluorescent materials of identical properties within each thread, but different between different threads.

5. Fluorescent Marker Reader apparatus of the claim 1 comprising further comprising Activator; Camera, further comprising at least one polarized filter and at least 2 megapixels of at least 3 types covering the spectral range of at least 400 through 1000 nm; Data base, able to store the responses of the Plurality of Fluorescent Entities of the claim 2,3,4, captured by the said Camera; Visualizing Screen able to display the scene; Computation Unit programmed to control the said Camera, Activator, Visualizing Screen; Controlling software installed on the said Computation Unit, able to control the said Camera, Activator, Visualizing Screen and perform converting a desired light pulse duration, spectral range and polarization into control signal of the said Activator, encoding, storage, matching the response of the said Fluorescent Marker for the purpose of identification and search on the scene methods of the claim 1.

6. Preferred embodiment of the Activator apparatus of the claim 5 comprises: at least one polarized filter of adjustable angle; at least of color filter; at least one light source able to generate a pulse of light of the length between 100 milliseconds and 1 millisecond, covering spectrum range at least between 300 through 1000 nm at total illumination levels power at 2000 through 200 lumen's in spread between 15 through 30 degrees of solid angle.

7. Method of the item Search on the Scene mode of operation of Fluorescent Marker Reader of the claim 1 in both its bar code and fluorescent embodiments as in claim 5 comprising the following steps: 1) Specification of the item to be found; 2) Item identification; 3) Choice of the item highlighting method on the marker or on the Visualizing Screen; Alternatively—implementation of 4a) on the marker highlighting of the claim 1 4b) Visualizing Screen of the claim 5.
